(19) United States
(12) Patent Application Publication
(10) Pub. No.: US 2024/0326299 A1
(43) Pub. Date: Oct. 3, 2024

(54) MOLD FOR FABRICATING A BULLET-TIPPED GLOVE AND METHOD OF MANUFACTURING SAME

(71) Applicant: Summit Glove Inc., Minerva, OH (US)

(72) Inventor: James L. Hull, Malvern, OH (US)

(73) Assignee: Summit Glove Inc., Minerva, OH (US)

(21) Appl. No.: 18/191,501

(22) Filed: Mar. 28, 2023

(51) Int. Cl. B29C 41/38; A41H 43/02; B29C 41/14

(52) U.S. Cl. CPC B29C 41/38; A41H 43/02; B29C 41/14; A41D 19/0055; B29K 2021/00; B29L 2031/4864

(57) ABSTRACT

A mold, system, and method of fabricating rubber gloves is disclosed. The mold includes a base, a forearm region, a wrist region, a palm region; and digit regions including a thumb region, an index finger region, a middle finger region, a ring finger region and a little finger region. The thumb, index finger, middle finger, ring finger, and little finger regions are configured in a splayed arrangement such that the mold has an appearance of a human hand with the thumb and fingers thereof flexed apart from one another. A plurality of molds are secured to a chain drive by individual mounting assemblies. During fabrication the chain drive moves the molds through liquid nitrile. Bubbles forming in the nitrile as the molds emerge from the liquid tend to pop close to the palm region of the mold because of the splayed configuration of the digit regions.

### TECHNICAL FIELD

This disclosure is directed to the manufacture of rubber gloves. In particular, the disclosure relates to a mold used in large chain molding of rubber gloves, particularly nitrile gloves. In particular, the disclosure is directed to an improved mold or form configured for producing medical gloves having at least some bullet-tip shaped fingertip regions. The improved mold has splayed digit regions, i.e., adjacent digit regions on the mold are spread out, extended, or expanded away from one another so that an angle of separation between adjacent digit regions is similar to when a human hand is flexed to move the fingers and thumb on that hand as far away from one another as is physically possible.

### BACKGROUND ART

Disposable rubber gloves, such as those made from latex, nitrile, polyvinyl chloride, and polychloroprene, are used in many applications to protect people's hands. The type of rubber selected for glove manufacture depends on the end application of the glove. Typically, nitrile and latex gloves are produced in a generally similar way. A plurality of ceramic or aluminum molds are utilized as formers during the manufacture of nitrile and latex gloves. Each ceramic or aluminum mold is in the shape of a human hand and includes a region similar in configuration to a portion of a person's wrist and forearm. The mold terminates in a base region which is used to operatively engage the mold with a chain drive. The chain drive manipulates and moves the plurality of molds through a series of process steps during glove production. In many of the process steps, the molds hang generally vertically downwardly from the chain such that the fingertips will be the first part of the mold to enter various liquids used in the production process and will be the last part of the mold to exit those liquids. The chain drive is also configured to individually rotate each mold about an axis which extends from base of the mold to a tip of a middle finger digit on the mold. Additionally, the chain drive is configured to individually pivot each mold between the generally vertical orientation and a generally horizontal orientation as required in various production steps.

In a first step during production, the plurality of molds are cleaned by progressively dipping and moving them (fingertip first) into one or more tanks of cleaning solutions such as soapy water and bleach. The cleaning solutions help to ensure any pieces of nitrile or latex from a previous production run are removed from an exterior surface of each mold. Failing to remove small pieces of rubber from the molds can lead to those pieces becoming incorporated into the next glove shaped on that mold. This can create a weak spot in the glove and possibly lead to the glove developing holes or tears during production or use.

After the molds exit the tanks of cleaning solution they may be passed between opposed pairs of rotating brushes. The bristles of these brushes contact the exterior surface of each mold and brush any remaining pieces of rubber therefrom. The molds are then progressively moved through a tank of hot water and are rotated to drip dry after exiting the water.

The plurality of molds is then progressively moved by the chain drive through one or more chemical baths to form a film on an exterior surface of each mold. The film is useful to enable rubber to adhere to the mold during a subsequent production step. The chemicals used in the chemical bath may include calcium nitrate and calcium carbonate. The calcium nitrate is provided to help coagulate rubber on the molds and the calcium carbonate acts as a lubricant which will later aid in removal of formed glove from the molds.

After the molds exit the chemical bath with the film formed on their exterior surfaces, they are progressively moved by the chain drive through a tank containing a quantity of liquid nitrile (or latex) therein. The nitrile or latex adheres to the film on the exterior surface of the molds and as the molds exit the tank they are individually rotated about their vertical axis so that any excess liquid nitrile or latex will tend to drip off the tips of the digit regions of the molds. The molds are then moved into and through an oven to dry the liquid rubber on the mold, thereby forming a glove. Once the nitrile or latex has dried, the molds are moved through tanks of water to thoroughly clean the exterior surfaces of the newly formed gloves.

During the production of nitrile gloves, after the gloves are washed and have dried, the molds will be moved by the chain drive through a series of brushes which will roll the wrist cuffs to form a bead. The new gloves are then stripped from the molds by an assembly line worker who grasps the beaded cuffs and pulls the glove off the molds. The chain to which the molds are operatively engaged then returns the molds to the first part of the process which any excess residue is washed and/or brushed therefrom. Latex gloves may not be moved through the series of brushes to bead the cuffs but, instead, will be stripped from the molds by a puff of air that is rapidly introduced into the interior of the glove.

Once of the issues with forming rubber gloves, particularly nitrile gloves, is that when the molds are rotated after exiting the tank of liquid rubber, it is not uncommon for a bubble of rubber to form in the gap between adjacent digit regions and to run along this gap towards the tips of the digit regions. In some instances, the bubble will burst and damage the rubber as it coagulates or sets on the mold. Such damaged gloves have to be discarded.

### SUMMARY OF THE INVENTION

The present disclosure is directed to a mold which is configured to aid in reducing the tendency of bubbles of rubber to form between adjacent digit regions of the mold during glove production. The configuration of the mold and the method of use thereof therefore may aid in reducing the number of gloves damaged during production and thereby increase the output of quality gloves produced by a facility.

A mold, system, and method of fabricating rubber gloves is disclosed herein. The mold includes a base, a forearm region, a wrist region, a palm region; and digit regions including a thumb region, an index finger region, a middle finger region, a ring finger region and a little finger region. The thumb, index finger, middle finger, ring finger, and little finger regions are configured in a splayed arrangement such that the mold has an appearance of a human hand with the thumb and fingers thereof flexed apart from one another. A plurality of molds are secured to a chain drive by individual mounting assemblies. During fabrication the chain drive moves the molds through liquid nitrile. Bubbles forming in the nitrile as the molds emerge from the liquid tend to pop close to the palm region of the mold because of the splayed configuration of the digit regions.

In one aspect, an exemplary embodiment of the present disclosure may provide a mold for forming a rubber glove, wherein the mold comprises a base; a forearm region extending outwardly from the base; a wrist region extending outwardly from the forearm region; a palm region extending outwardly from the wrist region; and digit regions extending outwardly from the palm region, wherein the digit regions includes a thumb region, an index finger region, a middle finger region, a ring finger region and a little finger region; wherein the thumb region, the index finger region, the middle finger region, the ring finger region and the little finger region are configured in a splayed arrangement, wherein the mold has an appearance of a human hand with the thumb and fingers flexed apart from one another.

In one embodiment, the index finger region and the middle finger region may be arranged at an angle of between 8 degrees and 14 degrees relative to one another. In one embodiment, the middle finger region and the ring finger region may be arranged at an angle of between 8 degrees and 14 relative to one another. In one embodiment, the ring finger region and the little finger region may be arranged at an angle of between 8 degrees and 14 relative to one another. In one embodiment, the index finger region and the thumb region may be arranged at an angle of between 8 degrees and 28 degrees relative to one another. In one embodiment, the mold may further comprise a fingertip region of a reduced circumference provided on at least one of the index finger region, the middle finger region, the ring finger region, the little finger region, and the thumb region. In one embodiment, the fingertip region may be bullet-tip shaped.

In another aspect, an exemplary embodiment of the present disclosure may provide a system for large batch molding of rubber gloves, wherein the system comprises a chain drive; a plurality of molds; and a plurality of mounting assemblies, wherein each mounting assembly is configured to operatively engage one of the plurality of molds to the chain drive; wherein each mold comprises a base that is operatively coupled to one of the plurality of mounting assemblies; a forearm region extending outwardly from the base; a wrist region extending outwardly from the forearm region; a palm region extending outwardly from the wrist region; and digit regions extending outwardly from the palm region, wherein the digit regions includes a thumb region, an index finger region, a middle finger region, a ring finger region and a little finger region; wherein the thumb region, the index finger region, the middle finger region, the ring finger region and the little finger region are configured in a splayed arrangement such that the mold has an appearance of a human hand with the thumb and fingers flexed apart from to one another.

In one embodiment, the index finger region and the middle finger region of the mold utilized in the system may be arranged at an angle of between xxx and xxx relative to one another. In one embodiment, the middle finger region and the ring finger region of the mold utilized in the system may be arranged at an angle of between xxx and xxx relative to one another. In one embodiment, the ring finger region and the little finger region of the mold utilized in the system may be arranged at an angle of between xxx and xxx relative to one another. In one embodiment, the index finger region and the thumb region of the mold utilized in the system may be arranged at an angle of between xxx and xxx relative to one another. In one embodiment, the mold utilized in the system may further comprise a fingertip region of a reduced circumference provided on at least one of the index finger region, the middle finger region, the ring finger region, the little finger region, and the thumb region. In one embodiment, the fingertip region may be bullet-tip shaped. In one embodiment each mounting assembly utilized in the system may be configured to selectively rotate the associated mold about a longitudinal axis of the mold, wherein the longitudinal axis extends between a tip of the middle finger region and the base. In one embodiment, each mounting assembly utilized in the system may be configured to selectively pivot the associated mold between a generally vertical orientation and a generally horizontal orientation.

In another aspect, and exemplary embodiment of the present disclosure may provide a method of forming rubber gloves in a large batch fabrication process; said method comprising providing a chain drive; providing a plurality of molds for forming the rubber gloves; operatively engaging each of a plurality of molds to the chain drive utilizing a separate mounting assembly; activating the chain drive to move the plurality of molds through a plurality of stations to form the rubber glove; and wherein providing the plurality of molds includes configuring each mold to include a base, a forearm region extending outwardly from the base, a wrist region extending outwardly from the forearm region, a palm region extending outwardly from the wrist region; and digit regions extending outwardly from the palm region, wherein the digit regions includes a thumb region, an index finger region, a middle finger region, a ring finger region and a little finger region; and configuring the thumb region, the index finger region, the middle finger region, the ring finger region and the little finger region in a splayed arrangement.

In one embodiment, configuring the thumb region, the index finger region, the middle finger region, the ring finger region and the little finger region in a splayed arrangement may include positioning the index finger region and the middle finger region are arranged at an angle of between 8 degrees and 14 degrees relative to one another; positioning the middle finger region and the ring finger region at an angle of between 8 degrees and 14 degrees relative to one another; positioning the ring finger region and the little finger region at an angle of between 8 degrees and 14 degrees relative to one another; and positioning the index finger region and the thumb region at an angle of between 8 degrees and 28 degrees relative to one another, such that the mold has an appearance of a human hand with the thumb and fingers thereof in a flexed apart arrangement relative to one another.

In one embodiment, activating the chain drive to move the plurality of molds through the plurality of stations to form the rubber glove may include orienting the plurality of molds in a fingertip-down position relative to the chain drive via the mounting assemblies; dipping the plurality of molds in a volume of liquid nitrile; coating a portion of an exterior surface of each of the plurality of molds in a quantity of liquid nitrile; removing the plurality of molds from the volume of liquid nitrile; causing part of the quantity of liquid nitrile to run down the palm region of each of the plurality of molds towards the digit regions thereof; forming a bubble in the liquid nitrile in a space defined between adjacent digit regions; and causing the bubble to burst in a position proximate the palm region because of the splayed arrangement of the digit regions.

In one embodiment, the method may further comprise providing a fingertip region of reduced circumference on at least one of the index finger region, the middle finger region, the ring finger region, the little finger region, and the thumb region; and causing the bubble to burst prior to reaching the fingertip region of reduced circumference. In one embodiment, providing the fingertip region of the reduced circumference may include forming the fingertip region into a bullet-tip shape.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1. is a front elevation view of a PRIOR ART mold for producing rubber gloves;

FIG. 2 is a front elevation view of a mold for producing rubber gloves, particularly nitrile gloves, in accordance with an aspect of the present disclosure;

FIG. 3 is a diagrammatic side elevation view of a section of a production line in which a plurality of molds is progressively and sequentially dipped in and subsequently removed from a tank containing liquid rubber, particularly liquid nitrile;

FIG. 4A is a rear elevation view of a first region of the production line taken along line 4A-4A of FIG. 3;

FIG. 4B is a rear elevation view of a second region of the production line taken along line 4B-4B of FIG. 3;

FIG. 4C is a rear elevation view of a third region of the production line taken along line 4C-4C of FIG. 3; and

FIG. 4D is a rear elevation view of a fourth section of the production line looking in the direction indicated by line 4D-4D of FIG. 3.

Similar numbers refer to similar parts throughout the drawings.

### DETAILED DESCRIPTION

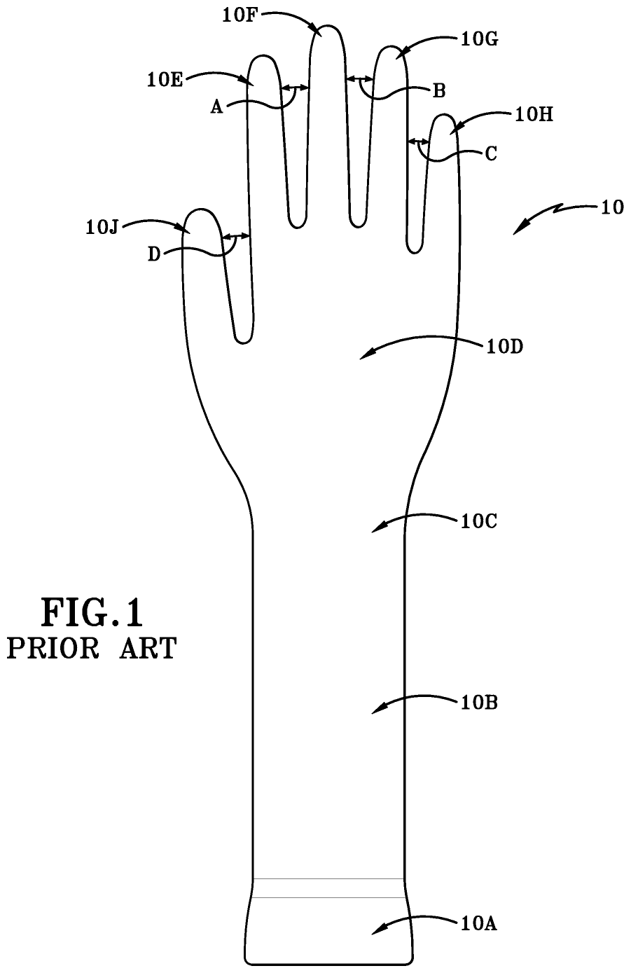

Referring to FIG. 1 there is illustrated a PRIOR ART mold for producing rubber gloves, particularly nitrile gloves, generally indicated at 10. Mold 10 includes a base 10A, a forearm region 10B, a wrist region 10C, a palm region 10D, and various digit regions. The various digit regions include an index finger region 10E, a middle finger region 10F, a ring finger region 10G, a little finger region 10H, and a thumb region 10J. It will be noted that the PRIOR ART mold 10 resembles a human hand when held in the air in a relaxed position. The index finger region 10E is separated from the middle finger region 10F by a first angle “A”; the middle finger region 10F is separated from the ring finger region 10G by a second angle “B”; the ring finger region 10G is separated from the little finger region 10H by a third angle “C”; and the thumb region 10J is separated from the index finger region 10E by a fourth angle “D”.

As indicated above, PRIOR ART mold 10 resembles a human hand in a relaxed position and the angle “A” is about 5 degrees, the angle “B” is about 5 degrees, the angle “C” is about 5 degrees, and the angle “D” is about 5 degrees.

This is the configuration of PRIOR ART mold 10 which may result in rubber bubbles forming between index finger region 10E and middle finger region 10F in the angle “A”; and/or between the middle finger region 10F and ring finger region 10G in the angle “B”; and/or between the ring finger region 10G and the little finger region 10H in the angle “C”, and/or between the thumb region 10J and index finger region 10E in the angle “D”.

It will be noted that the PRIOR ART mold 10 (also referred to herein as a “former 10”) is a mold for producing an ambidextrous glove. In particular, the index finger region 10E, middle finger region 10F, ring finger region 10G, little finger region 10H, and thumb region 10J will all be aligned in a same plane. In other instances, not shown herein, the PRIOR ART mold may, instead be a mold used to produce a hand-specific glove. For production of a hand-specific glove the thumb region will not be aligned in a same plane as the index finger region, middle finger region, ring finger region, and little finger region but will instead be offset from the plane in which the four finger regions are arranged (as is well known in the art). It should be noted that even a hand-specific PRIOR ART mold has a tendency for rubber bubbles to form between the thumb region and index finger region in a modified angle with respect to angle “D”, and/or between any of the other adjacent digit regions in the angles indicated as “A”, “B”, and “C”, the ambidextrous glove shown in FIG. 1.

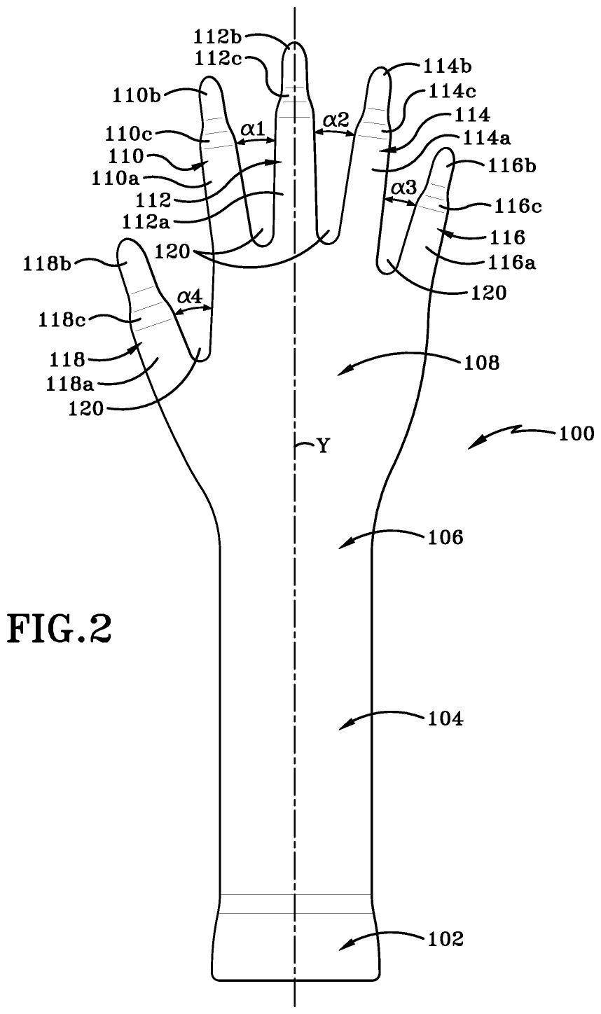

Referring now to FIGS. 2 through 4D, a mold in accordance with the present disclosure is illustrated, generally indicated at 100. Mold 100 includes a base 102, a forearm region 104, a wrist region 106, a palm region 108, and five digit regions. The five digit regions include an index finger region 110, a middle finger region 112, a ring finger region 114, a little finger region 116, and a thumb region 118.

In accordance with an aspect of the present disclosure and with reference to FIG. 2 in particular, it will be noted that the mold 100 resembles a human hand when held in the air in a splayed or flexed position instead of in the relaxed position of the PRIOR ART mold 10 shown in FIG. 1. FIG. 2 shows that mold 100 includes a longitudinal axis “Y” which extends along middle finger region 112 through to base 102.

In accordance with an aspect of the present disclosure, the index finger region 110 of presently-disclosed mold 100 is separated from the middle finger region 112 by a first angle “α1”; the middle finger region 112 is separated from the ring finger region 114 by a second angle “α2”; the ring finger region 114 is separated from the little finger region 116 by a third angle “α3” and the thumb region 118 is separated from the index finger region 110 by a fourth angle “α4”. Each of the angles “α1”, “α2”, “α3”, and “α4” is measured between the opposed inner surfaces of the two digit regions which form the angle. For example, the angle “α1” is measured between the inner surface of index finger region 110 and the opposed inner surface of middle finger region 112; and the angle “α3” is measured between the inner surface of ring finger region 114 and the opposed inner surface of little finger region 116.

The size of the angles “α1”, “α2”, “α3”, and “α4” is what arranges the mold's digit regions in the splayed or flexed arrangement. The purpose of this splayed or flexed arrangement of the digit regions of mold 100 will be described later herein.

As indicated above, mold 100 resembles a human hand in a flexed or splayed arrangement with the angle “α1” being from about 8 degrees up to about 14 degrees, the angle “α2” being from about 8 degrees up to about 14 degrees, the angle “α3” being from about 8 degrees up to about 14 degrees, and the angle “α4” being from about 8 degrees up to about 28 degrees. In one embodiment, the angles “α1”, “α2”, and “α3” are about 11 degrees and the angle “α4” is about 25 degrees. While the angles α1”, “α2”, and “α3” are indicated as being between 8 degrees and 14 degrees and the angle “α4” is indicated as being between 8 degrees and 28 degrees, it will be understood that these angles may be less than or more than the identified degrees that is adequate to reduce a tendency for bubbles to form in the digit regions during fabrication.

It will be noted that the mold 100 (also referred to herein as a “former 100”) is a mold for producing an ambidextrous glove. In particular, the index finger region 110, middle finger region 112, ring finger region 114, little finger region 116 and thumb region 118 will all be aligned in a same plane. In other instances, not shown herein, the mold of the present disclosure may, instead, be a mold used to produce a hand-specific glove. For production of a hand-specific glove the thumb region will not be aligned in a same plane as the index finger region, middle finger region, ring finger region, and little finger region but will instead be offset from that plane (as is well known in the art).

In accordance with an aspect of the present disclosure, one or more of the index finger region 110, middle finger region 112, ring finger region 114, little finger region 116, and thumb region 118 is configured to taper in circumference moving in a direction away from the palm region 108 of mold 100 and towards terminal ends of the various digit regions.

Referring to FIG. 2, index finger region 110 includes a first portion 110a, a second portion 110b, and a third portion 110c. Similarly, middle finger region 112 includes a first portion 112a, a second portion 112b, and a third portion 112c. Ring finger region 114 includes a first portion 114a, a second portion 114b, and a third portion 114c. Little finger region 116 includes a first portion 116a, a second portion 116b, and a third portion 116c. Finally, thumb region 118 comprises a first portion 118a, a second portion 118b, and a third portion 118c.

Each of the first portions 110a, 112a, 114a, 116a, and 118a originate in palm region 108 and extend outwardly therefrom moving in a direction towards a terminal end of the associated digit region. Each of the second portions 110b, 112b, 114b, 116b, and 118b originates in the terminal region of the associated digit region and extends inwardly in a direction towards the palm region 108. Each of the third portions 110c, 112c, 114c, 116c, and 118c is located between and is integral with each of the respective first portions 110a, 112a, 114a, 116a, and 118a and the respective second portions 110b, 112b, 114b, 116b, and 118b. Third portions 110c through 118c are positioned on mold 100 such that when a glove is formed with the mold and that glove is worn on a person's hand, the portion of the glove formed by the third portions of mold 100 will be located proximate a first knuckle on the person's hand.

In accordance with an aspect of the present disclosure, in each digit region the first portion is of a substantially constant circumference from where the first portion originates in the palm region 108 to where the third portion arises. (The circumference is measured at right angles to an axis extending along a length of the associated digit region.) The third portion tapers in circumference from where the third portion arises in the first portion to where the third portion terminates in the second portion. The second portion is of a substantially constant circumference from where the second portion arises to a terminal end of the respective digit region. The tapering third portions 110c through 118c may be configured as a skirt which flares outwardly from an innermost end of the associated second portion 110b through 118b moving in a direction towards the palm region 108 of mold 100.

In some embodiments, instead of the second portion being of substantially constant circumference, the second portion may taper in circumference from where the second portion arises in the third portion to the terminal end of the digit region. In these embodiments, the angle of taper of the second portion will be substantially less than an angle of taper of the third portion. In view of the arrangement of the first, second, and third portions of each digit region, the circumference of the first portion of each digit region is greater than the third portion and the circumference of the second portion is equal to or smaller than the smallest circumference of the tapering third region.

The third portions 110c through 118c and the associated second portions 110b through 118c form fingertip regions of the mold 100. When gloves are formed using mold 100, these specifically shaped and tapered fingertip regions will form similarly shaped and tapered fingertip regions on the gloves. The tapered fingertip regions on the glove will be pulled taut over the ends of a person's fingers when the glove is worn, improving the person's ability to sense things through the gloves, and improving the person's ability to grasp and handle objects.

It should be noted that while FIG. 2 shows that all of the five digit regions 110, 112, 114, 116, and 118 on the mold 100 have reduced circumference fingertip regions as described above, in other embodiments less than all five of the digit regions may include this reduced circumference fingertip region. For example in some embodiments, only the index finger region 110 will include a reduced circumference fingertip region of third portion 110c and second portion 110b. All four of the other digit regions will be of a substantially constant circumference from palm region 108 outwardly to the terminal ends of the four digit regions.

In other embodiments, both the index finger region 110 and middle finger region 112 will include the reduced circumference fingertip regions. In other words these molds will include third portions 110c, 112c and second portions 110b, 112b. All three of the other digit regions will be of a substantially constant circumference from palm region 108 outwardly to the terminal ends of those three digit regions.

In yet other embodiments, the index finger region 110, middle finger region 112 and thumb region 118 will include the reduced circumference fingertip regions. In other words these molds will include third portions 110c, 112c, 118c and second portions 110b, 112b, 118b. The remaining two digit regions will be of a substantially constant circumference from palm region 108 outwardly to the terminal ends of those two digit regions.

In yet other embodiments, only one of the digit regions may be of substantially constant circumference and all four of the other digit regions on the mold may include reduced circumference fingertip regions. It will be understood that any desired combination of digit regions with reduced circumference fingertip regions and digit regions of constant circumference may be provided on a mold in accordance with the present disclosure.

It should further be noted that in some embodiments the tapered third regions 110c through 118c may be completely omitted from some or all of the digit regions. In these embodiments the resultant digit region will comprise a longer length first portion which is integrally formed with the second portion. In these embodiments the fingertip region will be comprised substantially of only the smaller circumference second portion.

Mold 100 is configured so as to be useful in fabricating a glove with one or more fingertip regions which are tapered in circumference or are bullet-tip shaped. These specially configured reduced circumference fingertip regions provided on the formed glove will extend outwardly from proximate where a person's first knuckle on their fingers or thumb is located when the glove is worn. The gloves produced with the mold 100 are disclosed in detail in each of the following patents and applications, all of which are assigned to the present Applicant and are all incorporated herein by reference. The patents and applications are U.S. Pat. No. 9,968,145, issued May 15, 2018; U.S. Pat. No. 10,238,159 issued Mar. 26, 2019; U.S. Pat. No. 10,390,575 issued Aug. 27, 2019; U.S. Pat. No. 10,602,787, issued Mar. 31, 2020; U.S. Pat. No. 10,602,788 issued Mar. 31, 2020; U.S. Pat. No. 10,750,802 issued Aug. 25, 2020, U.S. Pat. No. 10,820,639 issued Nov. 3, 2020; U.S. Pat. No. 10,820,640 issued Nov. 3, 2020; U.S. Pat. No. 10,869,512 issued Dec. 22, 2020; U.S. Pat. No. 11,071,338 issued Jul. 27, 2021; U.S. Pat. No. 11,172,714 issued Nov. 16, 2021; U.S. Pat. No. 11,197,509 issued Dec. 14, 2021; U.S. Patent No. D890999 issued Jul. 21, 2020; U.S. Patent No. D910930 issued Feb. 16, 2021, and U.S. patent application Ser. No. 17/540,368, filed Dec. 2, 2021, and entitled “Drug Resistant Glove”.

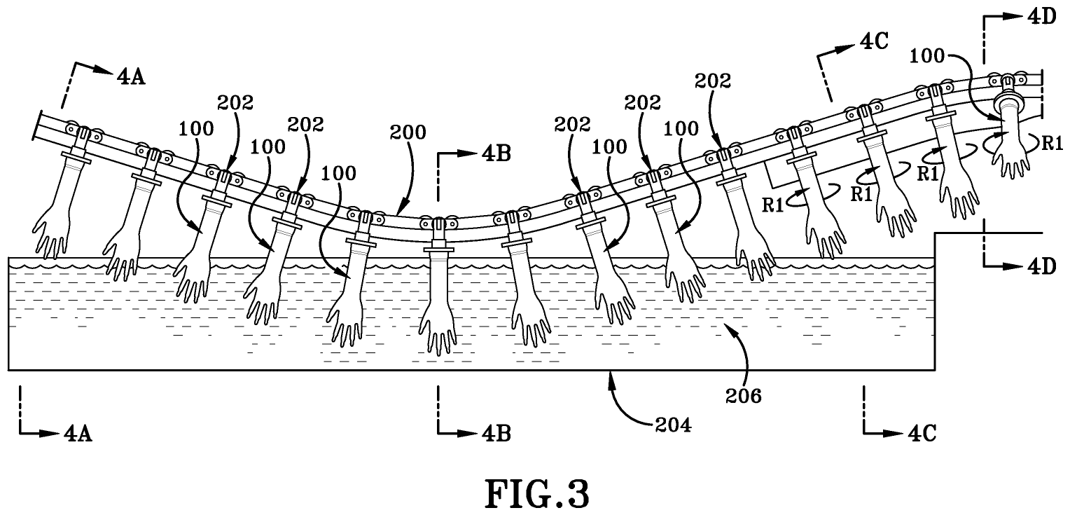

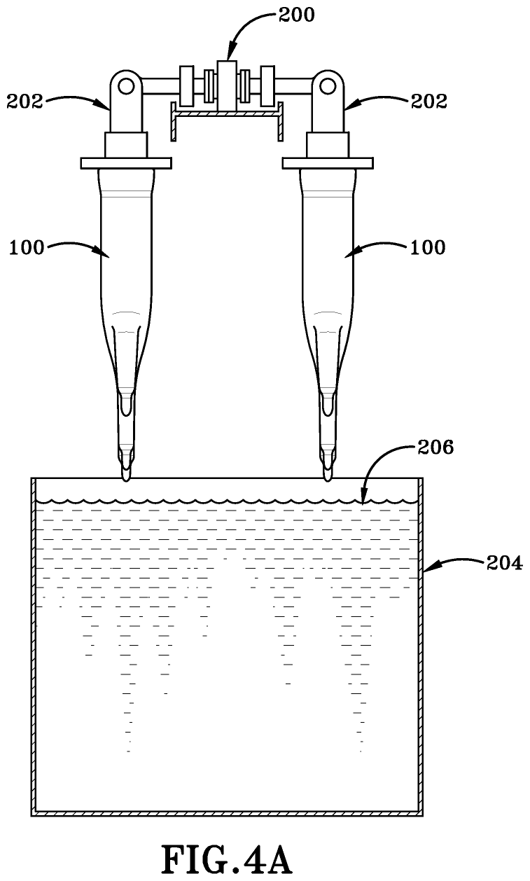

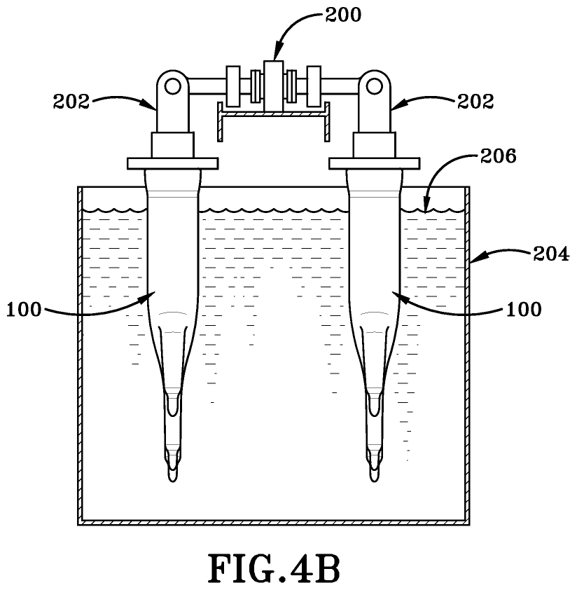

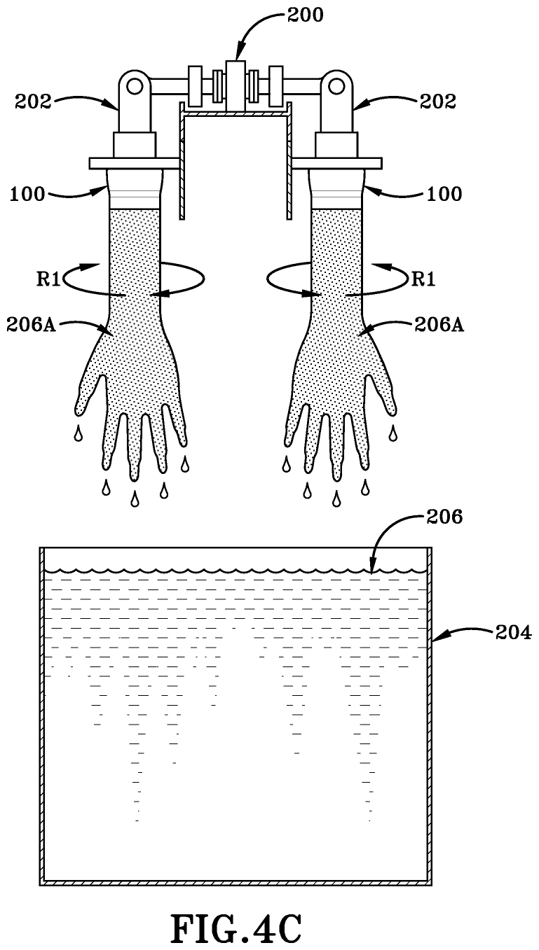

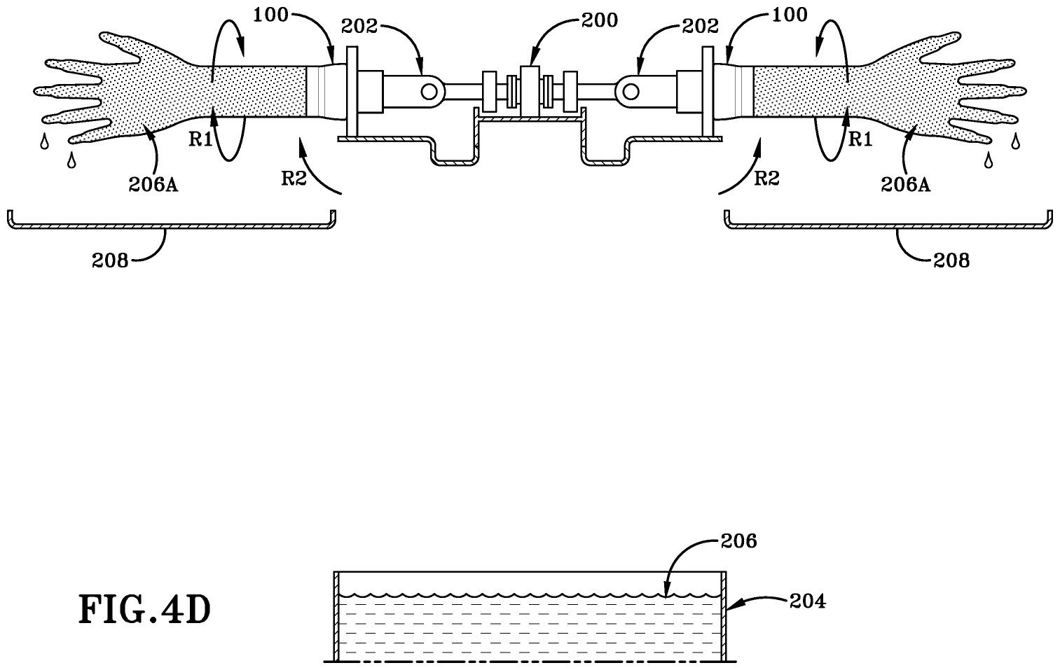

Referring to FIGS. 3-4D, mold 100 is used to fabricate the gloves described in the above-referenced patents and applications. FIG. 3 shows a plurality of substantially identical molds 100 engaged with a chain drive 200 via mounting assemblies 202. As best seen in FIGS. 4A through 4D, two rows of molds 100 may be connected to opposite sides of chain drive 200 so that double the number of gloves may be produced during a production run. Each mold 100 is individually operatively engaged with chain drive 200 by its own mounting assembly 202. Each mounting assembly 202 is separately actuatable to rotate, raise, or otherwise manipulate the associated mold 100 during a production run. Chain drive 200 is configured to move the plurality of molds 100 through various stations during the production run.

Although not illustrated in the attached figures it will be understood that chain drive 200, in a first step during production moves the plurality of molds 100 through a first station for cleaning. In this first station the molds 100 are cleaned by progressively dipping and moving them via the chain drive 200 through one or more tanks of cleaning solutions such as soapy water and bleach. The cleaning solutions help to ensure any pieces of rubber (nitrile or latex) from a previous production run are removed from an exterior surface of each mold 100.

After the molds 100 are cleaned, the chain drive 200 moves the molds 100 through opposed pairs of rotating brushes to brush the exterior surfaces of the molds 100. The chain drive 200 then moves the molds 100 through a tank of hot water. As the molds 100 are raised out of the tank of hot water, the mounting assemblies 202 may be actuated to rotate the molds 100 about longitudinal axis “Y” (FIG. 2) to allow the molds to drip dry rapidly.

Chain drive 200 then progressively moves the molds 100 through one or more chemical baths to form a film on an exterior surface of each mold 100. The film is applied to enable rubber to adhere to the molds 100 during a subsequent production step. None of the aforementioned steps are illustrated in the attached figures. Once the film is applied to the exterior surfaces of the molds 100, the chain drive 200 moves the molds 100 into and a through a tank 204 containing a volume of liquid rubber (particularly nitrile). This step is illustrated in FIG. 3. The chain drive 200 progressively and sequentially lowers the molds 100, fingertip regions first, into the liquid 206 within tank 204. Nitrile adheres to the film on the exterior surface of each of the molds 100 and the chain drive 200 progressively and sequentially lifts the molds 100 from the liquid 206.

As the molds 100 are raised out of the liquid 206, the mounting assemblies 202 are actuated to individually rotate the associated mold 100 about the mold's longitudinal axis “Y”. The rotation of each mold 100 is indicated in FIG. 3 by arrow “R1”.

The fingertip-down orientation of molds 100 combined with the rotation allows liquid nitrile to run down along the length of each of the digit regions 110 through 118 as the nitrile starts to form a film 206a (FIG. 4C) on an exterior surface of each mold 100. As this liquid nitrile runs down the length of the digit regions on mold 100, a bubble of liquid and air may form in the space 120 (FIG. 2) between adjacent digit regions. Such bubbles may form proximate palm region 108. This bubble of air and liquid will tend to flow downwardly through the space 120 between the adjacent digit regions which flank the space 120. Because of the provision of the splayed or flexed arrangement of the digit regions, the bubble of air and liquid will tend to burst closer to the palm region 108 than would be the case if the digit regions of mold 100 were not splayed. In particular, the splayed arrangement of the digit regions causes any such bubbles which form to burst before the bubbles reach the reduced circumference fingertip regions of the mold 100. The earlier bursting of any formed bubble provides an opportunity for liquid nitrile flowing downwardly from the palm region 108 to fill any gaps in the forming film of nitrile which may have been created as the bubble burst. The splayed arrangement of the digit regions of mold 100 therefore tends to reduce the likelihood of any holes developing in the glove being formed on mold 100.

Each mounting assembly 202 will continue to rotate the associated mold 100 as indicated by arrow “R1” as the chain drive 200 progressively raises the molds 100 out of the liquid 206 in tank 204. Mounting assembly 202 is then actuated to pivot the associated mold 100 from a substantially vertical orientation to a substantially horizontal orientation. This is shown in FIG. 4D where the pivoting motion is indicated by arrow “R2”. Chain drive 200 will then progressively move the molds 100 with the drying films 206a of nitrile thereon towards an oven to complete the formation of the nitrile film 206a into a glove. Once the nitrile has completely dried, chain assembly 200 moves the molds 100 through tanks of water to thoroughly clean the exterior surfaces of the newly formed gloves. Chain drive 200 then moves the molds 100 through a cuff beading station and then into a final station where the newly formed gloves are stripped from the molds 100 by hand. Chain drive 200 will then move molds 100 back into the first station for cleaning and removal of any unwanted bits and pieces of nitrile which may remain on the molds 100 after removal of the gloves therefrom.

In summary, a method of forming rubber gloves (particularly nitrile gloves) in a large batch fabrication process includes providing a chain drive 200; providing a plurality of molds 100 for forming the rubber gloves; operatively engaging each of the plurality of molds 100 to the chain drive 200 utilizing a separate mounting assembly 202; activating the chain drive 200 to move the plurality of molds 100 through a plurality of stations to form the rubber gloves. The step of providing the plurality of molds 100 includes configuring each mold 100 to include a base 102, a forearm region 104 extending outwardly from the base 102, a wrist region 106 extending outwardly from the forearm region 104, a palm region 108 extending outwardly from the wrist region 106; and digit regions extending outwardly from the palm region 108. The digit regions provided on the mold 100 include an index finger region 110, a middle finger region 112, a ring finger region 114, a little finger region 116, and a thumb region 118; and configuring the thumb region 118, the index finger region 110, the middle finger region 112, the ring finger region 114, and the little finger region 116 in a splayed arrangement.

Configuring the thumb region 118, the index finger region 110, the middle finger region 112, the ring finger region 114, and the little finger region 116 in a splayed arrangement may include positioning the index finger region 110 and the middle finger region 112 at an angle of between 8 degrees and 14 degrees relative to one another; positioning the middle finger region 112 and the ring finger region 114 at an angle of between 8 degrees and 14 degrees relative to one another; positioning the ring finger region 114 and the little finger region 116 at an angle of between 8 degrees and 14 degrees relative to one another; and positioning the index finger region 110 and the thumb region 118 at an angle of between 8 degrees and 28 degrees relative to one another, such that the mold 100 has an appearance of a human hand with the thumb and fingers thereof in a flexed apart arrangement relative to one another.

The method of fabricating rubber gloves further comprises activating the chain drive 200 to move the plurality of molds 100 through the plurality of stations to form the rubber glove. The method includes orienting the plurality of molds 100 in a fingertip-down position relative to the chain drive via the mounting assemblies 202 as shown in FIGS. 3 and 4; dipping the plurality of molds 100 in a volume of liquid nitrile 206 in a tank 204; coating a portion of an exterior surface of each of the plurality of molds 100 in a quantity of liquid nitrile 206 (to form a film 206a thereon); removing the plurality of molds 100 from the volume of liquid nitrile 206 in the tank 204; causing part of the quantity of liquid nitrile on the molds 100 to run down the palm region 108 of each of the plurality of molds 100 towards the digit regions 110 through 118 thereof; forming a bubble in the liquid nitrile 206a in a space 120 defined between adjacent digit regions 110 through 118; and causing the bubble to burst in a position proximate the palm region 108 on the associated mold 100 because of the splayed arrangement of the digit regions shown in FIG. 2.

The method may further comprise providing a fingertip region of reduced circumference on at least one of the index finger region 110, the middle finger region 112, the ring finger region 114, the little finger region 116, and the thumb region 118. In particular, the fingertip region is comprised of the second portion 110b through 118b; and the third portion 110c through 118c of each respective digit region. This fingertip region may be of a bullet-tip shape as illustrated in FIG. 2. During fabrication, if a bubble is formed in the liquid nitrile, that bubble tends to be caused to burst prior to reaching the fingertip region of reduced circumference because of the splayed arrangement of the digit regions 110 through 118.

It will be understood that the various steps of the production run may be different than described above. The described production run is simply exemplary of how nitrile, latex or other rubber gloves may be produced using the mold 100 of the present disclosure.

The advantage of the mold 100 of the present disclosure over PRIOR ART mold 10 (FIG. 1) is that mold 100 enables the production of gloves with a reduced tendency to develop holes if and when bubbles of liquid rubber and air form in the spaces between the digit regions of the mold.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A mold for forming a rubber glove, wherein the mold comprises:
a base;
a forearm region extending outwardly from the base;
a wrist region extending outwardly from the forearm region;
a palm region extending outwardly from the wrist region;
digit regions extending outwardly from the palm region, wherein the digit regions includes a thumb region, an index finger region, a middle finger region, a ring finger region and a little finger region; and
wherein the thumb region, the index finger region, the middle finger region, the ring finger region and the little finger region are configured in a splayed arrangement, wherein the mold has an appearance of a human hand with thumb and fingers flexed apart from one another.

2. The mold according to claim 1, wherein the index finger region and the middle finger region are arranged at an angle of between 8 degrees and 14 degrees relative to one another.

3. The mold according to claim 1, wherein the middle finger region and the ring finger region are arranged at an angle of between 8 degrees and 14 degrees relative to one another.

4. The mold according to claim 1, wherein the ring finger region and the little finger region are arranged at an angle of between 8 degrees and 14 degrees relative to one another.

5. The mold according to claim 1, wherein the index finger region and the thumb region are arranged at an angle of between 8 degrees and 28 degrees relative to one another.

6. The mold according to claim 1, further comprising a fingertip region of a reduced circumference provided on at least one of the index finger region, the middle finger region, the ring finger region, the little finger region, and the thumb region.

7. The mold according to claim 6, wherein the fingertip region is bullet-tip shaped.

8. A system for large batch molding of rubber gloves, wherein the system comprises:
a chain drive;
a plurality of molds;
a plurality of mounting assemblies, wherein each mounting assembly is configured to operatively engage one of the plurality of molds to the chain drive;
wherein each mold comprises:
a base that is operatively coupled to one of the plurality of mounting assemblies;
a forearm region extending outwardly from the base;
a wrist region extending outwardly from the forearm region;
a palm region extending outwardly from the wrist region;
digit regions extending outwardly from the palm region, wherein the digit regions includes a thumb region, an index finger region, a middle finger region, a ring finger region and a little finger region; and
wherein the thumb region, the index finger region, the middle finger region, the ring finger region and the little finger region are configured in a splayed arrangement such that the mold has an appearance of a human hand with thumb and fingers flexed apart from to one another.

9. The system according to claim 8, wherein the index finger region and the middle finger region of the mold are arranged at an angle of between 8 degrees and 14 relative to one another.

10. The system according to claim 8, wherein the middle finger region and the ring finger region of the mold are arranged at an angle of between 8 degrees and 14 relative to one another.

11. The system according to claim 8, wherein the ring finger region and the little finger region of the mold are arranged at an angle of between 8 degrees and 14 relative to one another.

12. The system according to claim 10, wherein the index finger region and the thumb region of the mold are arranged at an angle of between 8 degrees and 28 relative to one another.

13. The system according to claim 8, further comprising providing a fingertip region of a reduced circumference on at least one of the index finger region, the middle finger region, the ring finger region, the little finger region, and the thumb region of the mold.

14. The system according to claim 8, wherein each mounting assembly is configured to selectively rotate an associated mold about a longitudinal axis of the mold, wherein the longitudinal axis extends between a tip of the middle finger region and the base.

15. The system according to claim 8, wherein each mounting assembly is configured to selectively pivot an associated mold between a generally vertical orientation and a generally horizontal orientation.

16. A method of forming rubber gloves in a large batch fabrication process; said method comprising:
providing a chain drive;
providing a plurality of molds for forming the rubber gloves;
operatively engaging each of the plurality of molds to the chain drive utilizing a separate mounting assembly;
activating the chain drive to move the plurality of molds through a plurality of stations to form the rubber gloves; and
wherein providing the plurality of molds includes configuring each mold to include a base, a forearm region extending outwardly from the base, a wrist region extending outwardly from the forearm region, a palm region extending outwardly from the wrist region; and digit regions extending outwardly from the palm region, wherein the digit regions includes a thumb region, an index finger region, a middle finger region, a ring finger region and a little finger region; and configuring the thumb region, the index finger region, the middle finger region, the ring finger region and the little finger region in a splayed arrangement.

17. The method according to claim 16, wherein configuring the thumb region, the index finger region, the middle finger region, the ring finger region and the little finger region in a splayed arrangement includes positioning the index finger region and the middle finger region are arranged at an angle of between 8 degrees and 14 degrees relative to one another; positioning the middle finger region and the ring finger region at an angle of between 8 degrees and 14 degrees relative to one another; positioning the ring finger region and the little finger region at an angle of between 8 degrees and 14 degrees relative to one another; and positioning the index finger region and the thumb region at an angle of between 8 degrees and 28 degrees relative to one another, such that the mold has an appearance of a human hand with thumb and fingers thereof in a flexed apart arrangement relative to one another.

18. The method according to claim 17, wherein activating the chain drive to move the plurality of molds through the plurality of stations to form the rubber glove includes:
orienting the plurality of molds in a fingertip-down position relative to the chain drive via the mounting assemblies;
dipping the plurality of molds in a volume of liquid nitrile;
coating a portion of an exterior surface of each of the plurality of molds in a quantity of liquid nitrile;
removing the plurality of molds from the volume of liquid nitrile;
causing part of the quantity of liquid nitrile to run down the palm region of each of the plurality of molds towards the digit regions thereof;
forming a bubble in the liquid nitrile in a space defined between adjacent digit regions; and
causing the bubble to burst in a position proximate the palm region because of the splayed arrangement of the digit regions.

19. The method according to claim 17, further comprising providing a fingertip region of reduced circumference on at least one of the index finger region, the middle finger region, the ring finger region, the little finger region, and the thumb region; and causing the bubble to burst prior to reaching the fingertip region of reduced circumference.

20. The method according to claim 19, wherein providing the fingertip region of the reduced circumference includes forming the fingertip region into a bullet-tip shape.
